(19) United States
(12) Patent Application Publication
(10) Pub. No.: US 2010/0277461 A1
(43) Pub. Date: Nov. 4, 2010

(54) SYSTEMS AND METHODS TO DRIVE AN LCD

(75) Inventor: T. N. Ruckmongathan, Bangalore (IN)

Correspondence Address: SHEPPARD, MULLIN, RICHTER & HAMPTON LLP, 990 Marsh Road, Menlo Park, CA, 94025, US

(73) Assignee: Raman Research Institute, Bangalore (IN)

(21) Appl. No.: 12/486,260

(22) Filed: Jun. 17, 2009

(30) Foreign Application Priority Data
May 4, 2009 (IN) 1039/CHE/2009

(51) Int. Cl. G06F 3/038

(52) U.S. Cl. 345/213; 345/94

(57) ABSTRACT

In various embodiments, the largest transition in the select waveform of successive approximation technique is eliminated to reduce power dissipation in liquid crystal displays. Power dissipation in the driver circuit is analyzed for gray scale images for several select sequences. They are compared and new select sequences are proposed to achieve low power dissipation. A combination of pulse width modulation for MSBs and pulse height modulation for LSBs to form discrete trapezoidal waveforms is used to reduce peak amplitude of select and data waveforms and achieve a low supply voltage and low power dissipation in the driver circuit.

### CROSS-REFERENCE TO RELATED APPLICATIONS

This application claims priority under 35 U.S.C. §119(a) to Indian Patent Application No. 1039/CHE/2009, filed on May 4, 2009, entitled “A Method to Drive LCD” which is incorporated herein by reference in its entirety. Priority in the U.S. is claimed under.

### TECHNICAL FIELD

The present invention relates generally to Liquid Crystal Displays (LCDs) and more specifically to systems and methods to drive an LCD.

### BACKGROUND OF THE INVENTION

Flat panel displays viz., LCDs, Electro luminescent (EL) and Plasma display panels (PDP) have capacitive type pixels and are modeled as a two-dimensional array with capacitors that are located at the intersection of row and column address lines. A major component of power consumption in these displays is the power dissipation in the driver circuit when pixels are charged and discharged to voltages that are determined by addressing waveforms. Multi-step waveforms have been proposed to reduce power dissipation in LCD. Several waveforms, for example, triangular, trapezoidal as well as their discrete versions with multi-steps, can be used to reduce power dissipation in driver circuit of bi-level displays where pixels are driven to either ON or OFF states. Of the several techniques to display gray shades in LCDs, successive approximation techniques and wavelet-based techniques require less hardware to display a large number of gray shades and it is possible to reduce power dissipation of these techniques.

### SUMMARY OF THE INVENTION

Some embodiments described herein are related to low power technique for gray shades in Liquid Crystal displays (LCDs). Methods to achieve low power dissipation in LCDs with high efficacy are also disclosed herein. In some embodiments, addressing waveforms are modified to achieve low supply voltage and low power. Average power dissipation in drivers of LCD may be analyzed and compared for several line-by-line addressing techniques that are based on energy multiplexing.

In some embodiments, an object of the instant invention is to provide a method to drive LCDs such that the average power dissipated is reduced. Accordingly, methods are described to drive matrix liquid crystal display (LCD) with discrete trapezoidal shaped select and/or data waveforms by applying select and/or data pulse corresponding to alternate least significant bits (LSB) to form ascending and descending parts of the discrete trapezoid and by reducing the amplitudes and increasing widths of most significant bit(s) (MSB) pulse(s) to form the flat part of the trapezoid and reducing number of transitions in the flat region of trapezoids in the addressing waveforms by using pulse width modulation.

### BRIEF DESCRIPTION OF THE DRAWINGS

FIG. 1 shows addressing waveforms of a successive approximation technique that is based on selecting one address line at a time (SAT-L1).

FIG. 2 shows ‘Select sequence-a’ that is held at non-select voltage during (T₀/2) and the first step has unit amplitude. Amplitude of select pulses is increased by a factor \sqrt{2} for each bit starting from least significant bit (LSB) to the most significant bit (MSB). It is followed by an abrupt transition to zero and it is held at zero during (T₀/2) at the end of the select time T of an address line.

FIG. 3 shows a select sequence with ascending and descending select voltages to eliminate the largest transition in ‘sequence-a.’ Number of transitions is about twice that of ‘sequence-a.’

FIG. 4 shows a New select sequence that has the same number of transitions as that of ‘sequence-a’ is shown. The largest transition in ‘profile-a’ is eliminated but amplitude of other transitions increases by a factor ‘a’ (\sqrt{2}).

FIG. 5 shows plots that compare power dissipation in the series resistance of RC-an circuit during the period T when the capacitor is charged and discharged with the capacitor with the three select sequences.

FIG. 6 shows an equivalent circuit of a matrix type LCD at a given instant of time, the number of ON and OFF pixels in the selected and non-selected rows depends on the row that is selected as well as the image.

FIG. 7 shows an equivalent circuit of a matrix display during a select time when the data voltages correspond to the gray shades.

FIG. 8 shows a comparison of power dissipation when select voltage sequences a-c is used in addressing waveforms. The sequence-c is better than sequence-b because sequence-b has double the number of transitions as compared to sequence-c.

FIG. 9 shows a photograph of the prototype that is capable of displaying 128 gray shades.

FIG. 10 shows waveforms captured using an oscilloscope including, from the top: row waveform, column waveform and waveform across the pixel; in the same order.

FIG. 11(a) and 11(b) shows select waveforms of Successive approximation Technique. It is referred as FIG. 11 in the description when both figures are considered together.

FIG. 12(a) and 12(b) shows select waveforms of Hadamard Matrix Based Technique. It is referred as FIG. 12 in the description when both figures are considered together.

FIG. 13(a) and 13(b) shows select waveforms of Diagonal matrix based Technique. It is referred as FIG. 13 in the description when both figures are considered together.

FIG. 14(a) and 14(b) shows select waveforms of Wavelet based addressing Technique. It is referred as FIG. 14 in the description when both figures are considered together.

FIG. 15 shows waveforms of MLA that are based on sparse matrix in equation (1) with distributed select pulses.

FIG. 16 illustrates each pulse in FIG. 15 is substituted with discrete version of ramp waveform to display a large number of gray shades by using SAT and to reduce power dissipation in row drivers.

FIG. 17 illustrates each pulse in FIG. 15 is substituted with discrete version of triangular waveform to reduce power dissipation in drivers when a large number of gray shades are displayed using SAT.

FIG. 18 illustrates one of the eight data voltages is introduced as the fourth voltage in the row waveform and the same voltage is applied to all columns to achieve zero voltage across all pixels during the ‘dead time (T₀)’ to achieve full utilization of hardware in the row and column drivers.

FIG. 19 shows typical waveforms, from the top: row waveform, column waveform, and the waveform across a pixel in that order.

FIG. 20 shows a plot of normalized supply voltage.

FIG. 21 shows ratios of supply voltage showing the reduction in supply voltage of the technique.

### DETAILED DESCRIPTION OF THE INVENTION

It is to be understood that while the invention has been described in conjunction with the preferred specific embodiments thereof, the foregoing description as well as the examples that follow are intended to illustrate and not to limit the scope of the invention. Other aspects, advantages and modifications within the scope of the invention will be apparent to those skilled in the art to which the invention pertains.

The following examples are put forth so as to provide those of ordinary skill in the art with a complete disclosure and description of how to make and use the invention. The examples are intended as non-limiting examples of the invention.

A successive approximation technique that selects one address line at a time (SAT-L1) may be well suited for low power applications because drivers that are capable of selecting one out of two voltages that are used for driving bi-level displays may be adequate to display a large number of gray shades. SAT-L1 can display 2 g gray shades in g time intervals as compared to (2^{g}−1) time intervals that may be necessary in case of pulse width modulation and frame rate control. The number of voltages in the column (data) waveforms of SAT-L1 is small (2.g) for displaying 2^{g} gray shades as compared 2^{(g+1)} voltages in waveforms of the pulse amplitude modulation. Although the number of data voltages of SAT_L1 is large, just one of two data voltages are applied at any given instant of time. Two g:1 analog multiplexers are used to select two data voltages among the 2.g data voltages. The selection ratio (ratio of RMS voltage across ON pixels to that across OFF pixels) of SAT is the maximum as compared to the row pulse height modulation. Hardware complexity of drivers may be the lowest for SAT-L1. Drivers that are capable of applying one out of two voltages may be adequate to display gray shades with SAT-L1. A method to reduce power dissipation and supply voltage of SAT-L1 is disclosed herein. A similar approach may be adapted to reduce power dissipation of addressing techniques with multiple select pulses including successive approximation based on multi-line addressing techniques and wavelets-based techniques. SAT-L1 is described briefly herein.

Successive Approximation Technique based on Line-by-Line Addressing (SAT-L1)

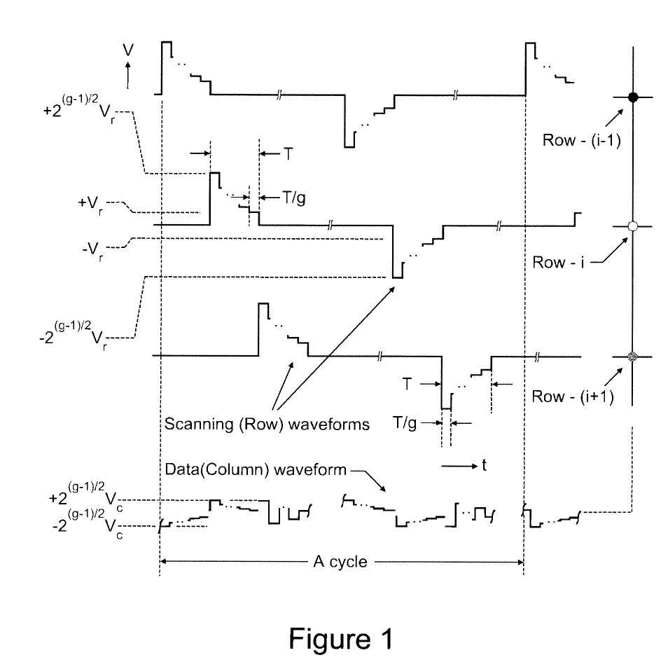

Address lines (either rows or columns) in a matrix display may be selected sequentially each with ‘g’ pulses (of different amplitudes) during a period T as shown in FIG. 1. In this embodiment, T is the select time of an address line and g is the number of bits that is used to represent gray shades of pixels. The amplitude of select pulses is proportional to the weight of gray shade bits. In one example, let Vᵣ be the amplitude of the select pulse that corresponds to the least significant bit (LSB). The amplitude of the select pulse is increased by a factor \sqrt{2} for each higher bit. The maximum amplitude of select pulses viz. (2^{(g-1)/2}Vᵣ) corresponds to the most significant bit (MSB). The address lines (say rows) are selected with a pulse of amplitude 2^{(g-1)/2}Vᵣ for the duration (T−T₀)/g and the rest of the address lines are grounded. A data voltage of +2^{(g-1)/2}V_{c} is applied to the column of the matrix display, if MSB of the pixel located in that column is ‘logic-0’ and a data voltage of −2^{(g-1)/2}V_{c} is applied to a column if MSB of the pixel is ‘logic-1.’

In general, if an address line is selected with a voltage (2^{k/2}Vᵣ) corresponding to the bit-k during a time interval, then the amplitude of data voltages will be proportional to (2^{k/2}) whereas the sign of data voltage will be same as the select pulse if bit-k is logic-0 and opposite to that of select pulse if the bit-k is logic-1. The display may be refreshed continuously by selecting each address line with g-select pulses corresponding to the gray shade bits and the N-address lines are sequentially selected with ‘g’ select pulses as shown in FIG. 1. The polarity of the select pulses is periodically reversed to ensure DC free waveforms across the pixels. This technique may achieve the maximum selection ratio (defined as the ratio of RMS voltage across the ON pixels to that across the OFF pixels). The principle of reducing power dissipation in some embodiments is described next.

Addressing waveforms of the LCD may not be unique because the root mean square (RMS) voltage across the pixel may determine its state and it is possible to achieve the desired RMS voltage across pixels with several addressing techniques. In some embodiments, the shape of the addressing waveforms may be important to reduce power consumption as in the case of an RC-circuit with a resistor and a capacitor in series; wherein a slowly varying ramp waveform to charge (or discharge) a capacitor will minimize the power dissipated in the resistor. Power dissipation is proportional to square of the step voltage and may be preferable to avoid large transitions in the addressing waveforms. Almost all the addressing techniques for driving LCD are based on pulses (to select address lines) with abrupt transitions. Replacing ‘pulses’ with ‘triangular waveforms’ may minimize power dissipation. A 50% reduction in power dissipation may be achieved when pixels are charged or discharged in two steps with a staircase waveform having equal steps of amplitude (V/2) instead of a single step of amplitude V. The order of application (sequence) of select pulses may not be important for displaying gray shades because the RMS voltage may be independent. However, the power dissipated in drivers may depend on the sequence because the step size of transitions may be different for different sequences. The transition from ±2^{(g-1)/2}Vᵣ to 0 in select waveforms and the transition from ±2^{(g-1)/2}V_{c} to 0 in data waveforms of SAT-L1 (shown in FIG. 1) may be the major contributors to power dissipation in the driver circuit. For example, about 63 to 85% (for g=2 to 8) of power may be dissipated when a capacitor is charged to a voltage 2^{(g-1)/2}V and the rest of the power is dissipated when the capacitor is discharged with g-steps wherein the voltage is reduced by a factor (1/\sqrt{2}) during each transition. There may be considerable scope to reduce power by decreasing the amplitude of transitions as evident from this example. Some select sequences are considered in the next section.

Three sequences of select pulses are considered and are evaluated for their potential to reduce power dissipation in RC circuit before introducing them in to the addressing techniques.

### A. Select Sequence-a

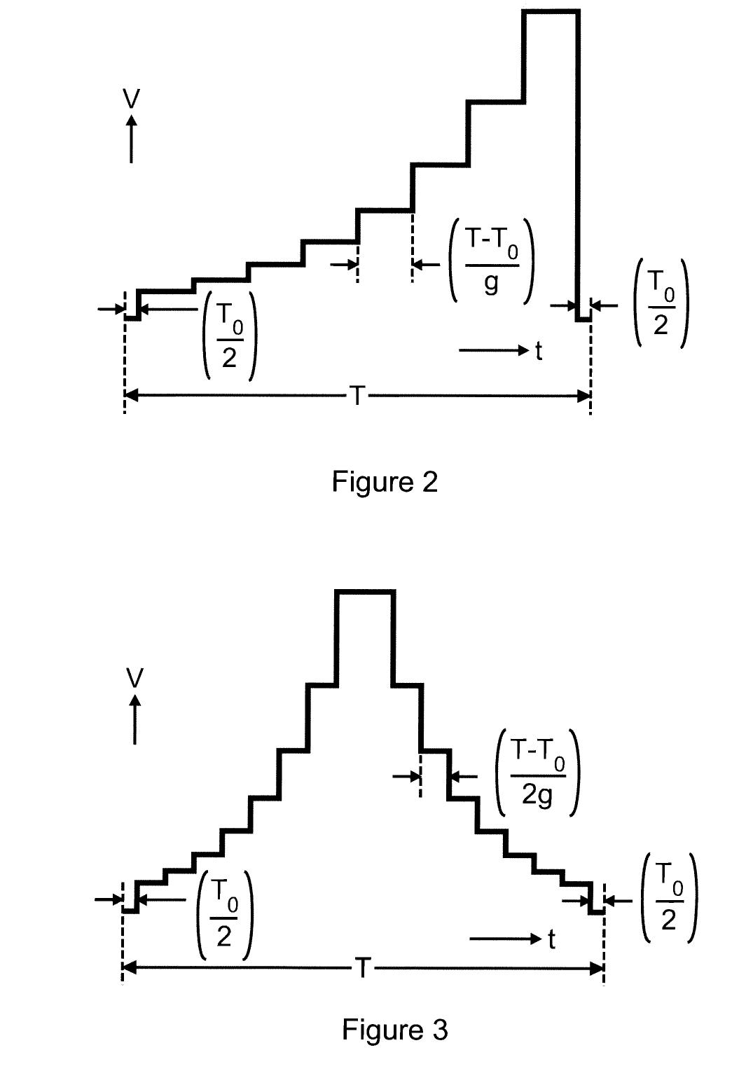

Select pulses are arranged in ascending order starting from a pulse of unit amplitude that corresponds to the LSB (amplitude of the select pulse is normalized to that of LSB). An amplitude of each successive pulse is increased by a factor-α during the transition. The final select pulse of amplitude α^{(g-1)} corresponds to the MSB and the final transition from α^{(g-1)} to zero is the largest transition in the select waveform. This sequence shown in FIG. 2 is considered the reference sequence to compare other sequences discussed herein and it is referred to as ‘select sequence-a.’ The power dissipated in the series resistor of an RC-circuit is proportional to the expression in (1):

$$p ( a ) ∝ [ 1 + {\sum }_{k = 1}^{n} {( {a}^{k} - {a}^{( k - 1 )} )}^{2} + {a}^{2 n} ] \qquad ( 1 )$$

Here, the first term corresponds to 0 to 1 transition. The summation in the second term corresponds to transitions from the select pulse of LSB to the final pulse corresponding to the MSB. The last term corresponds to transition from voltage corresponding to MSB to 0 (non-select voltage). The expression in (1) simplifies to the expression in (2):

$$p ( a ) ∝ \frac{2 \cdot {a}^{( 2 n + 1 )} + 2}{( a + 1 )} \qquad ( 2 )$$

Power dissipated in the series resistance of RC-circuit, when the capacitor is charged with ‘g’ select pulses and discharged to zero is obtained by substituting ‘(g−1)’ for ‘n’ because k=1 corresponds to the 2^{nd} transition from 1 to a¹ as shown in (3):

$$p ( a ) ∝ \frac{2 \cdot {a}^{2 g - 1} + 2}{a + 1} ∵ n = g - 1 \qquad ( 3 )$$

Select pulses may also be arranged in descending order as the waveforms of the SAT-L1 in FIG. 1. The select sequence of SAT-L1 in FIG. 1 may be equivalent to that in FIG. 2 from the point of power dissipation because the amplitude of transitions and the number of transitions may be the same for both the sequences.

### B. Select Sequence-b

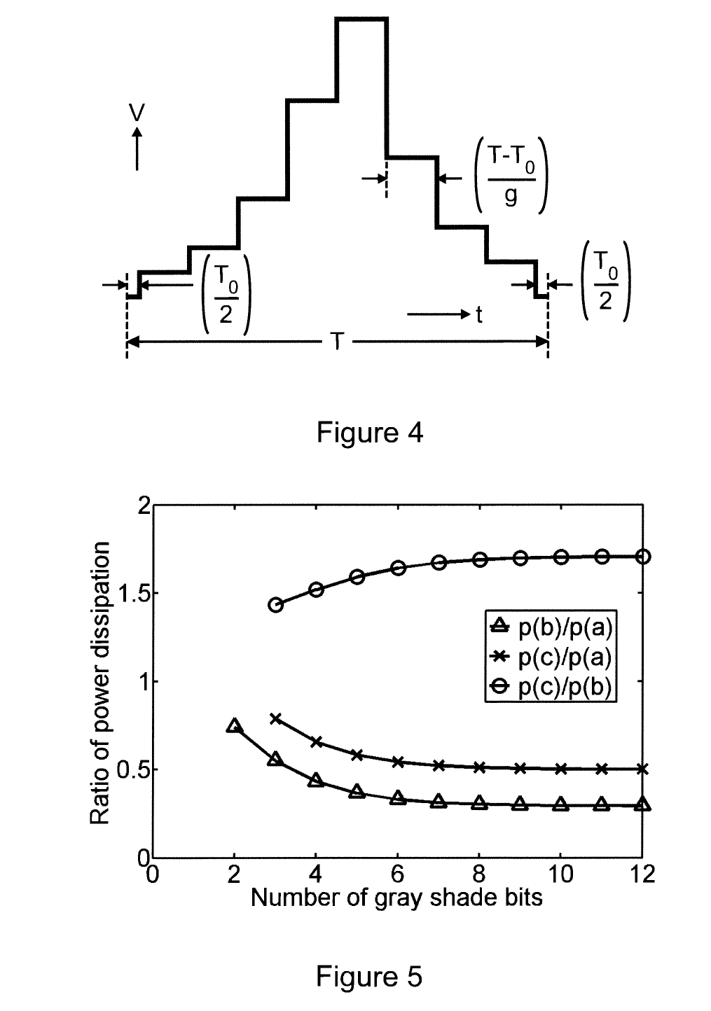

The largest transition in ‘sequence-a’ can eliminated by concatenating ‘g’ select pulses corresponding to MSB to LSB in descending order to the select pulses (in ascending order) of FIG. 2 as shown in FIG. 3. Hence, the number of transitions in the resulting sequence ‘select sequence-b’ is almost double that of the ‘select sequence-a’. It has 2g transitions as compared to (g+1) transitions of ‘sequence-a’. The display can be addressed with the ‘sequence-b,’ however, the duration of select pulses will be about half that of select ‘sequence-a’ except for the pulse corresponding to MSB; if the duration of select time of address lines T is the same as that of sequence to ensure that the display is refreshed at the same rate in both the cases. The first and last pulses of ‘sequence-b’ correspond to LSB and the peak voltage of waveform in FIG. 3 corresponds to MSB. The peak voltage is proportional to a^{(g-1)} and it is wider as compared to other voltages. The amplitude of select pulses may be reduced by a factor a to obtain the descending part of the select waveform. Power dissipated in the series resistor, when the capacitor in RC-circuit is charged and discharged with waveform of ‘sequence-b,’ is given by the expression in (4):

$$p ( b ) ∝ 2 ( 1 + {\sum }_{k = 1}^{n} {( {a}^{k} - {a}^{k - 1} )}^{2} ) \qquad ( 4 )$$

The first term corresponds to transition from 0 to 1 and from 1 to 0. The summation in the second term may correspond to rest of the transitions.

$$p ( b ) ∝ \frac{2 \cdot {a}^{2 n} ( a - 1 ) + 4}{( a + 1 )} \qquad ( 5 )$$

Here again, n=(g−1) may correspond to the transition to (or from) the select voltage corresponding to MSB from (to) the next significant bit and the simplified expression for the power dissipation in a resistor of an RC circuit is shown in (6):

$$p ( b ) ∝ \frac{2 \cdot {a}^{2 ( g - 1 )} ( a - 1 ) + 4}{( a + 1 )} \qquad ( 6 )$$

Power dissipation of ‘sequence-b’ may be compared with that of the select ‘sequence-a’ by taking the ratio of (6) to (3) and by assigning α=\sqrt{2} as in the case of successive approximation techniques.

$$\frac{p ( b )}{p ( a )} = \frac{{2}^{g} ( 2 - \sqrt{2} ) + 4 \sqrt{2}}{2 ( {2}^{g} + \sqrt{2} )} \qquad ( 7 )$$

Power dissipation of sequence-b is about 70% of ‘sequence-a’ when g=2, and it asymptotically reaches to about 30% for higher values of ‘g’ (g>8).

Although the ‘sequence-b’ has the potential to reduce power dissipation, it may have double the number of transitions as compared to ‘sequence-a.’ In some embodiments, it is preferable to have a fewer number of transitions in addressing waveforms to achieve good brightness uniformity of pixels for the following reasons:
1. The RMS voltage across pixels may be reduced due to distortion of pulses in the addressing waveforms. The difference between ideal and actual RMS voltages may increase with the number of transitions when the frame frequency is a constant. Frequency spectrum of waveforms across pixels may shift towards higher frequencies as the number of transitions is increased. Some high frequency components may be greater than the crossover frequency of dielectric relaxation of liquid crystal mixture in the display and the effective RMS voltage across pixels may be reduced.

Hence, poor brightness uniformity among pixels that are driven to same gray shade may be due to transitions and select sequences with less number of transitions can minimize the non-uniformity.

C. Select sequence-c

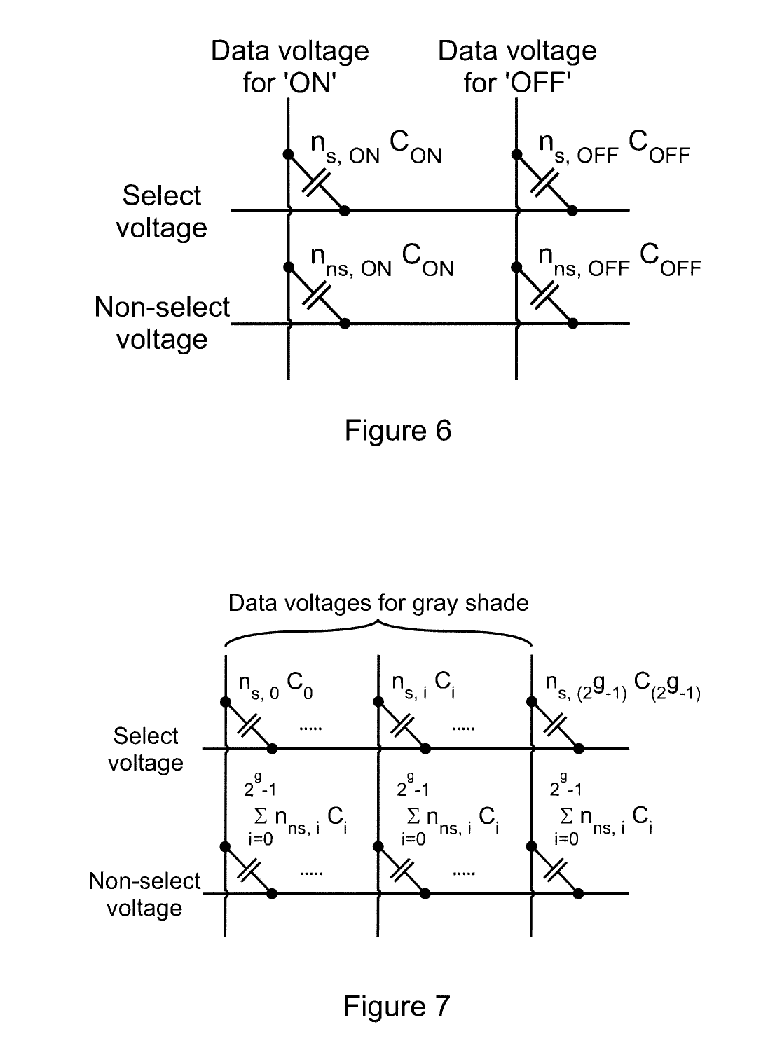

The select ‘sequence-c’ that is shown in FIG. 4 has the same number of transitions as that of ‘sequence-a’ and yet it eliminates the largest transition in ‘sequence-a.’ A select sequence with ascending as well as descending steps may be achieved by arranging select pulses corresponding to alternate bits to appear adjacent to each other and therefore have both ascending as well as descending order with just ‘g’ pulses as shown in FIG. 4 (i.e., select pulses of odd numbered bits from LSB to MSB may form the ascending part and that of even numbered bits from MSB to LSB may form the descending part OR, alternately, the select pulses of even numbered bits from LSB to MSB may form the ascending part and that of odd numbered bits from MSB to LSB may form the descending part of the discrete triangle). The step size of ascending steps is α² as compared to ‘a’ of sequence-a’ and ‘sequence-b.’ Similarly, the amplitude is reduced in steps of α⁻² in the descending steps as compared to α⁻¹ in ‘sequence-b.’ Power dissipated in the RC circuit when the ‘sequence-c’ is used to charge and discharge a capacitor is as follows:

$$p ( c ) ∝ [ 1 + {a}^{2} + {( {a}^{n} - {a}^{( n - 1 )} )}^{2} + {\sum }_{k = 2}^{n} {( {a}^{k} - {a}^{( k - 2 )} )}^{2} ] \qquad ( 8 )$$

Here, the first term corresponds to the unit step, the second term corresponds to the final transition from a to zero, the third term corresponds to the transition ‘from’ or ‘to’ the peak voltage ‘to’ or ‘from’ an adjacent pulse of lower amplitude, and the summation in the last term corresponds to the transitions with step size of either α² or α⁻². It simplifies to the expression in (9) and it can further be compared with sequence-a by the ratio in (10) after substituting \sqrt{2} for the step size α.

$$\begin{matrix}p ( c ) ∝ 2 \cdot ( a - 1 ) \cdot {a}^{( 2 g - 3 )} - {a}^{2} + 2 & ( 9 ) \\ \frac{p ( c )}{p ( a )} = \frac{{2}^{g} + 2 \sqrt{2} ( \sqrt{2} + 1 )}{2 ( {2}^{g} + \sqrt{2} )} & ( 10 )\end{matrix}$$

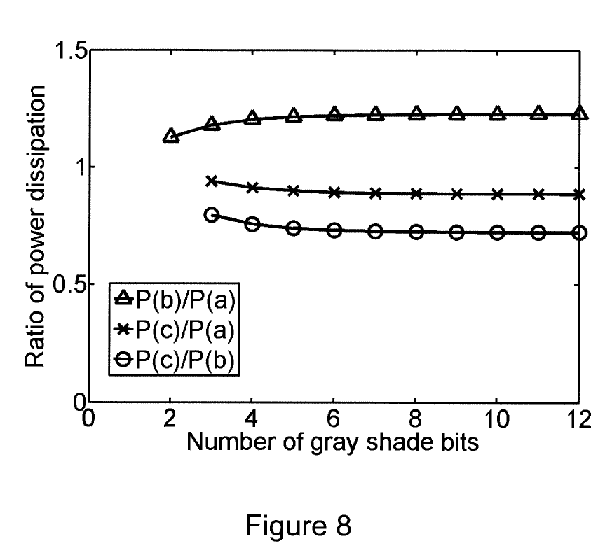

Power dissipation in the RC circuit with ‘sequence-c’ is less as compared to that of ‘sequence-a;’ it is about 79% of ‘sequence-a’ and it asymptotically approaches 50% when g is greater than 8 as shown in FIG. 5. However, it is more than that of ‘sequence-b’ as shown by the plot of ratio p(c)/p(b) in the figure. Analysis and comparison of power dissipation when these sequences are used to drive matrix display is discussed in the next section.

### Analysis of Power Consumption

A matrix type LCD is modeled as a two dimensional array of capacitors. Liquid crystal mixtures exhibit dielectric anisotropy. The effective dielectric constant depends on the molecular orientation with reference to the electric field because the dielectric constants that is measured parallel and perpendicular to the long axis of rod-like liquid crystal molecules are not equal. Hence, the pixels are equivalent to voltage dependent capacitors because the orientation of the molecules depends on the voltage across the pixel. In twisted nematic (TN) and super twisted nematic (STN) liquid crystal displays, the capacitance of a pixel that is ON (C_{ON}) may be higher by a factor of two or more than the capacitance of same pixel in OFF state (C_{OFF}). Capacitance of the pixels that are driven to some intermediate gray shade may be within the capacitance of the two extreme states (ON and OFF). Hence, the power dissipation in a matrix LCD may depend on the actual image and prior knowledge of the image is necessary to compute the power dissipated in the driver circuit through analysis.

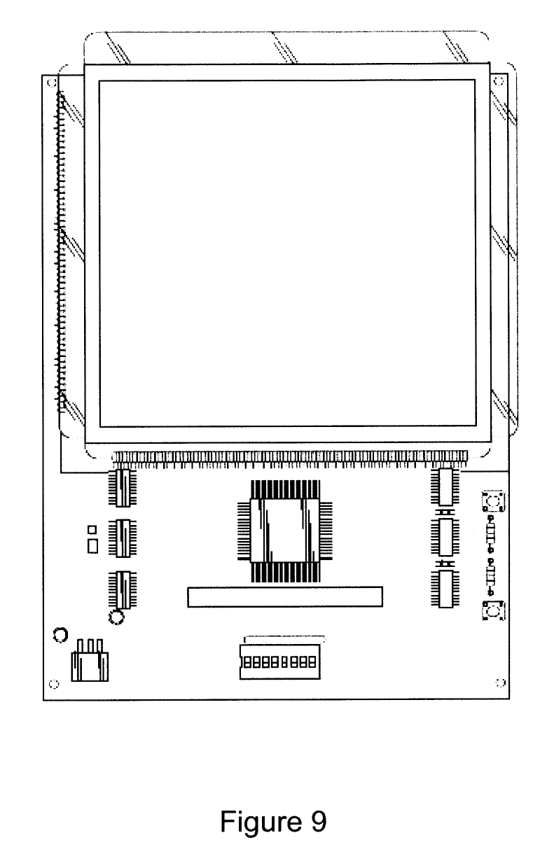

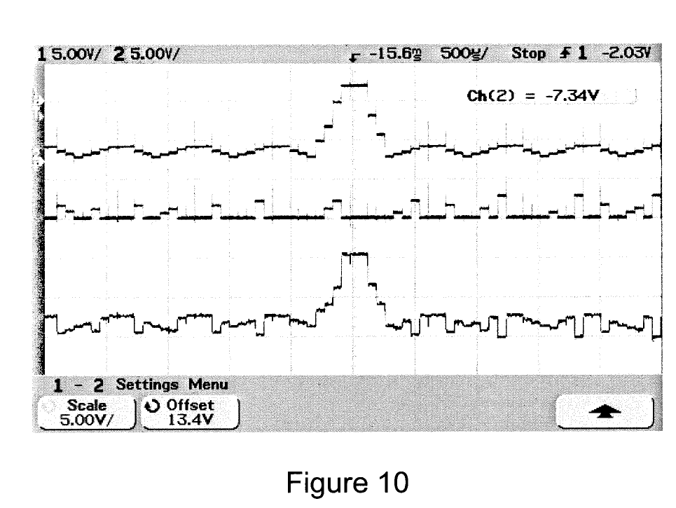

It may not be necessary to know the image for comparing different waveforms because we can take the ratio by assuming that image is the same for both the cases. The equivalent circuit of a matrix display when select and data voltages are applied during a short period (T−T₀)/g is given in FIG. 6. Here, n_{s,ON} is the number of pixels that are driven to ON state in a selected row. n_{s,OFF} is the number of OFF pixels in the selected row. n_{ns,ON} is the number of ON pixels in non-selected rows. n_{ns,OFF} is the number of OFF pixels in the non-selected rows. Both the select and data waveforms may have similar transitions (except of polarity of the data waveforms) in a bi-level display. Therefore, the reduction or increase in power dissipation may be the same as in the case of simple RC circuit as compared in FIG. 5. The equivalent circuit of a matrix LCD during a select time may be relatively more complex when gray shades are displayed as shown in FIG. 7. Here, n_{s,i} is the number of pixels in the selected row that are being driven to the gray shade ‘i’ and, similarly, n_{ns,i} is the number of pixels in the non-selected rows that are driven to the gray shade ‘i.’ The pixels in the non-selected rows may get voltages corresponding to the state of the pixels in the selected row and, therefore, the pixels in non-selected rows are grouped into 2^{g} columns depending on column voltages that correspond to 2^{g} gray shades. Capacitance of pixels in non-selected rows add up and amplitude of transitions across them is relatively small because just the data voltages appear across them as compared to the large transitions across the pixels in selected rows but the capacitances are small as compared to that in non-selected rows. In some embodiments, the relative merits of select profiles are estimated with the following assumptions:
1. Capacitance of pixels does not follow the abrupt changes in addressing waveforms because liquid crystal molecules take time to reorient themselves to the electric field.
2. Period of the addressing waveform is small as compared to the response times.
3. RMS voltage across the pixel is same for a gray shade irrespective of the profile of select pulses and, therefore, capacitance of the pixel depends on its gray shade.
4. Capacitance of all pixels is assumed equal to simplify the analysis although the capacitance depends on gray shade of the pixel. An average value can be assumed by considering the fact that capacitances of pixels that are driven to the same gray shade add up and similarly capacitances of pixels in non-selected rows add up because they are parallel to each other.
5. Probability of occurrence of all the gray shades in the image is assumed to be equal, to obtain a closed form expressions for power dissipation.

In these embodiments, these assumptions are valid because liquid crystal molecules are slow to follow and orient themselves to the time varying voltages of the addressing waveforms and response times are usually larger than the period of a cycle. Although not all gray shades may be equally probable in small regions of an image and to a lesser extent over large images, it gives an estimate of power dissipation when there is no prior knowledge of the image. It is important to note that the transitions across the pixels in non-selected rows may depend on the gray shades of pixels in the two rows that are selected one after other successively. In various embodiments, all possible transitions in the data voltages are equally probable when we assume that the gray shades are equally probable and we can get closed form expression for power dissipation. The objective may be to compare the power dissipation of different sequences of select pulses by taking ratios and, therefore, it is not necessary to know the capacitances of pixels. The relative efficiency of select sequences may be obtained after ensuring that the RMS voltages are equal for all the select sequences by proper choice of amplitude of select pulses.

In some embodiments, let us consider a voltage transition from αⁱVᵣ to α^{j}Vᵣ in the select waveform in a matrix display with N rows and M columns. The corresponding transition in data voltages can be any one of the four possibilities depending on the gray scale data of the pixel; viz. +αⁱV_{c} to +a^{j}V_{c}, +αⁱV_{c} to −α^{j}V_{c}, −αⁱV_{c} to +α^{j}V_{c} and −αⁱV_{c} to −α^{j}V_{c}. All these are equally probable because the distribution of gray shade is assumed to be uniform. Hence, the power dissipated in the pixels during the select time will be proportional to the expression in (11):

$${p}_{i - j \_ select} ∝ \{ \begin{matrix}{( {a}^{j} ( {V}_{r} + {V}_{c} ) - {a}^{i} ( {V}_{r} + {V}_{c} ) )}^{2} + \\ {( {a}^{j} ( {V}_{r} - {V}_{c} ) - {a}^{i} ( {V}_{r} + {V}_{c} ) )}^{2} + \\ {( {a}^{j} ( {V}_{r} + {V}_{c} ) - {a}^{i} ( {V}_{r} - {V}_{c} ) )}^{2} + \\ {( {a}^{j} ( {V}_{r} - {V}_{c} ) - {a}^{i} ( {V}_{r} - {V}_{c} ) )}^{2}\end{matrix} \} \qquad ( 11 )$$

The expression in (11) simplifies to:

pᵢ₋ⱼ_{_{—}}_{select}∝4Vᵣ²(α^{j}−αⁱ)²+4V_{c}²(α^{2.i}+α^{2.j}) (12)

Similarly, the power dissipation across pixels during the non-selected time intervals will be proportional to:

$${p}_{i - j \_ non - select} ∝ \{ \begin{matrix}{( {a}^{j} - {a}^{i} )}^{2} {V}_{c}^{2} + {( {a}^{j} + {a}^{i} )}^{2} {V}_{c}^{2} + \\ {( - {a}^{j} - {a}^{i} )}^{2} {V}_{c}^{2} + {( - {a}^{j} + {a}^{i} )}^{2} {V}_{c}^{2}\end{matrix} \} \qquad ( 13 )$$

The expression in (13) can also be obtained by substituting ‘0’ for Vᵣ in (12) and it simplifies to the following expression:

pᵢ₋ⱼ_{_{—}}_{non-select}∝4V_{c}²(α^{2.i}+α^{2.j}) (14)

Power dissipated in a matrix LCD (with N rows) when the select voltage transits from iVᵣ to jVᵣ during a scan is:

pᵢ₋ⱼ_{_{—}}_{scan}∝(α^{j}−αⁱ)²Vᵣ²+N(α^{2.i}+α^{2.j})V_{c}² (15)

Average power dissipated under the assumption of uniform distribution of gray shades is proportional to:

$$P ∝ {\sum }_{∀ all {a}^{i} \to {a}^{j}} ( {( {a}^{j} - {a}^{i} )}^{2} {V}_{r}^{2} + ( {a}^{2 \cdot i} + {a}^{2 \cdot j} ) {NV}_{c}^{2} ) \qquad ( 16 )$$

It is clear from the above expression that reduction in average power dissipation depends on magnitude as well as the order in which select pulses appear in the waveform (sequence) and the magnitude of data voltages. However, it does not depend on the order in which the data voltages appear because we have assumed a uniform distribution of gray shades and therefore data waveforms will have equal number of positive and negative transitions from each data voltage to another. Further, power dissipation due to transitions in the data waveforms is independent of sequence of the select voltages but it may depend on the sequence of transitions in the scanning waveform. Power dissipated when the select sequences a, b and c are used as the row waveforrn is analyzed in the following equations; sequence-a shown in FIG. 2 is considered first.

$$\begin{matrix}{P}_{select\_seq ( a )} ∝ [ \begin{matrix}{V}_{r}^{2} ( 1 + {a}^{2 \cdot ( g - 1 )} + {\sum }_{k = 1}^{g - 1} {( {a}^{k} - {a}^{( k - 1 )} )}^{2} ) + \\ {NV}_{c}^{2} ( 1 + {a}^{2 \cdot ( g - 1 )} + {\sum }_{k = 1}^{g - 1} {a}^{2 \cdot k} + {a}^{2 \cdot ( k - 1 )} )\end{matrix} ] & ( 17 ) \\ {P}_{select\_seq ( a )} ∝ N ( ( 4 - \sqrt{2} ) \cdot {2}^{g} + 2 \sqrt{2} - 4 ) {V}_{c}^{2} & ( 18 ) \\ {P}_{select\_seq ( b )} ∝ 2 [ \begin{matrix}{V}_{r}^{2} ( 1 + {\sum }_{k = 1}^{g - 1} {( {a}^{k} - {a}^{( k - 1 )} )}^{2} ) + \\ N \cdot {V}_{c}^{2} ( 1 + {\sum }_{k = 1}^{g - 1} {a}^{2 k} + {a}^{2 ( k - 1 )} )\end{matrix} ] & ( 19 ) \\ {P}_{select\_seq ( b )} ∝ N ( ( 3 - \sqrt{2} ) \cdot {2}^{( g + 1 )} + 4 \sqrt{2} - 8 ) {V}_{c}^{2} & ( 20 ) \\ {P}_{select\_seq ( c )} ∝ [ \begin{matrix}{V}_{r}^{2} ( 1 + {a}^{2} + {( {a}^{( g - 1 )} - {a}^{( g - 2 )} )}^{2} + {\sum }_{k = 2}^{g - 1} {( {a}^{k} - {a}^{( k - 2 )} )}^{2} ) + \\ {NV}_{c}^{2} ( 1 + {a}^{2} + {a}^{2 ( g - 1 )} + {a}^{2 ( g - 2 )} + {\sum }_{k = 2}^{g - 1} {a}^{2 \cdot k} + {a}^{2 \cdot ( k - 1 )} )\end{matrix} ] & ( 21 ) \\ {P}_{select\_seq ( c )} ∝ N {2}^{g} [ 3 - \frac{\sqrt{2}}{2} ] {V}_{c}^{2} & ( 22 )\end{matrix}$$

The unit step of column voltage V_{c} that corresponds to LSB in the successive approximation technique with the duty cycle (select voltage held at non-select voltage during a period To in the select time of T) is given in the following equation:

$${V}_{c} = \sqrt{\frac{T}{T - {T}_{0}}} \cdot \sqrt{\frac{g}{{2}^{g} - 1}} \cdot ( \sqrt{\frac{N}{2 ( N - \sqrt{N} )}} ) \cdot {V}_{th} \qquad ( 23 )$$

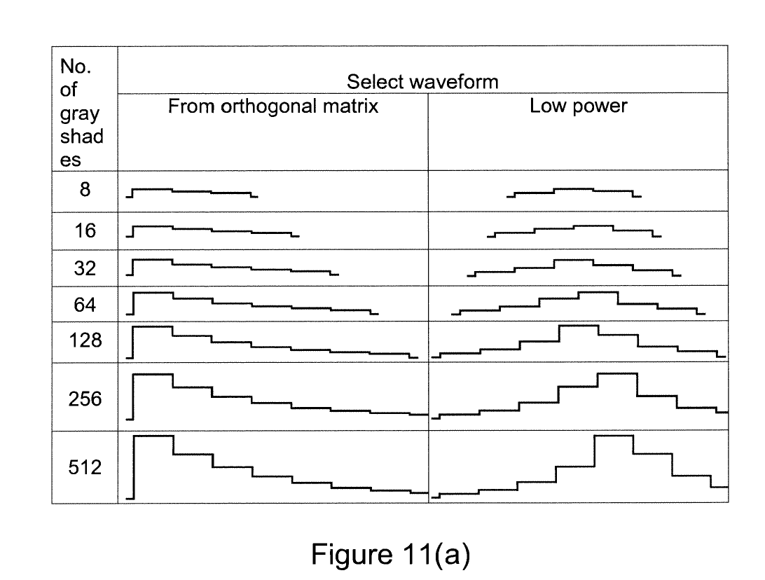

Here, T₀ is the time within T (one row select period), during which both the row and column voltages are brought to common potential to ensure brightness uniformity and Vₜₕ is the threshold voltage of the electro optic characteristics of the display. It is considered equal for the above three waveform sequences because pulse widths of all three are the same. The average power dissipation of the multiplexed waveforms with select sequences is compared in FIG. 8. ‘Sequence-c’ may be better than ‘sequence-b’ to reduce power dissipation when gray shades are displayed in a matrix display when we assume that the entire (2^{g}) gray shades are equally probable. It is in contrast to that of both the simple RC-circuit and that of matrix displays where in ‘sequence-b’ is better than ‘sequence-c’ for the following reasons, in some embodiments.

In various embodiments, the magnitude of transition during select time is always less than the magnitude of select pulse when the pixels are driven to OFF state. However, when gray shades are displayed, power dissipation during select time is high for some of the gray shades. For example, the gray shades: 010101 . . . OR 101010 . . . (i.e., when alternate gray shade bits are not same) introduce a large swing across the pixels during select time as compared to the case when neighboring gray shades are the same as in OFF or ON pixels.

The supply voltage of the driver circuit may be reduced by decreasing the amplitude of the select pulse corresponding to MSB by a factor (1/\sqrt{2}) and the width may be doubled so that its amplitude is same as that of the next lower significant bit. Let us consider a pulse of duty cycle

$$\frac{{T}_{p}}{T}$$

then the RMS voltage is

$$\sqrt{\frac{1}{T} {\int }_{0}^{{T}_{p}} {V}^{2} d t} = V \sqrt{\frac{{T}_{p}}{T}} .$$

If we are interested to reduce the amplitude of the pulse by a factor (1/\sqrt{2}) and still want to retain the RMS voltage, then it can be achieved by increasing the pulse width to 2·Tₚ so that

$$\sqrt{\frac{1}{T} {\int }_{0}^{2 \cdot {T}_{p}} {( \frac{V}{\sqrt{2}} )}^{2} d t} = V \sqrt{\frac{{T}_{p}}{T}} .$$

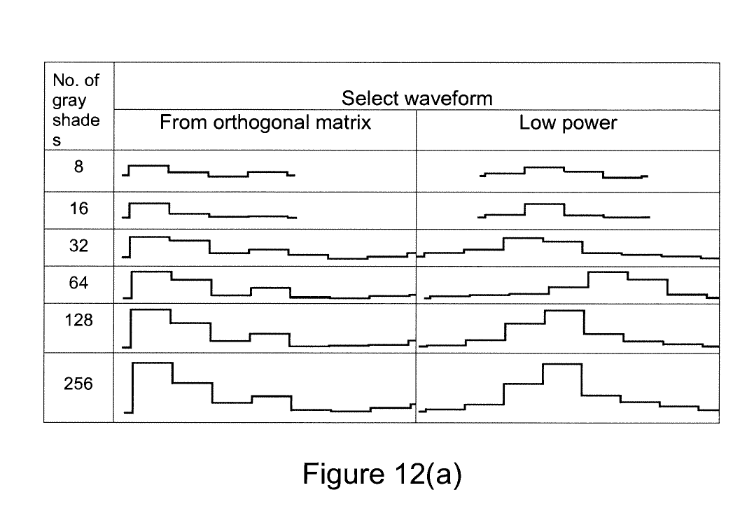

Hence, when the voltage corresponding MSB is reduced, an additional pulse is introduced and these two pulses along with the pulse of the next significant bit form a flat top of width 3 as in FIG. 10. The amplitude of the select pulses may increase by a factor \sqrt{(g+1)/g} due to the fact that the select time of a row is left intact so that the frame refresh rate remains the same even after modifying the waveform. Hence, the supply voltage may be reduced to \sqrt{(g+1)/(2g)} of supply voltage before the modification of waveform. A 25% reduction in supply voltage is achieved by reducing the amplitude of the select pulse corresponding to MSB when the number of bits is eight. Power dissipation may be approximately equal to that of (g−1) bits when the supply voltage is decreased by a factor \sqrt{(g+1)/(2g)} with this method. The method to reduce the supply can be extended to include more number of bits and it is equivalent to using pulse width modulation for most significant bits and amplitude modulation for the least significant bits. The select waveform may be equivalent to discrete version of trapezoidal waveform, which is a good choice for reducing power consumption as well as the supply voltage.

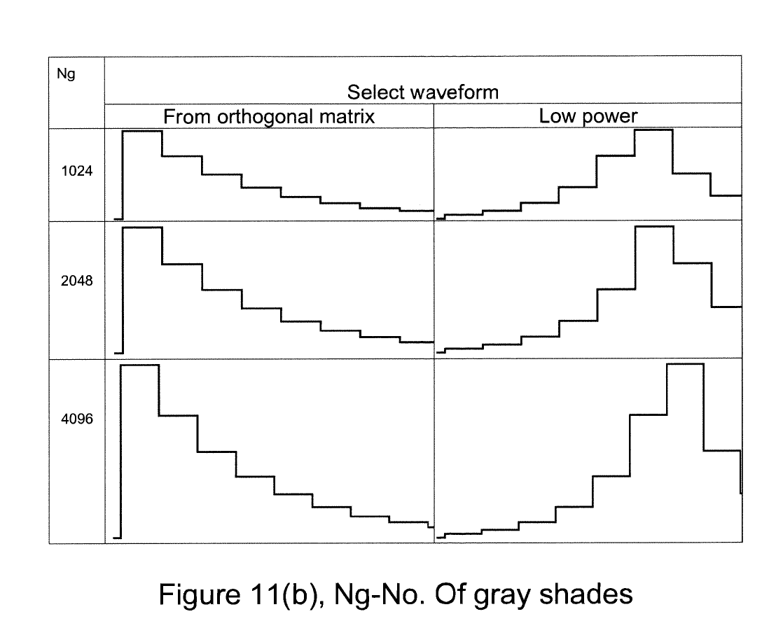

The technique may be demonstrated with a 32×32 matrix LCD by displaying 128 gray shades. In some embodiments, it can use any one of the 3 select waveforms shown in Table 1 to scan the display. We have measured the current in the analog part of the drivers and have measured the current for the 3-select waveforms and 4 images as shown in the table. It was measured with Agilent 34410A digital multi-meter by integrating for 2 seconds. Power consumption is proportional to square of the current. Hence, the ratio of square of the current of select waveforms in rows 1 and 2 (profiles ‘a’ and ‘c’) to that of the waveform 3 (profile-b) are expressed in % in the table I for the sake comparison. Theoretical values obtained through analysis are shown within parenthesis in the first column. The image in first column consists of all the 128 gray shades occurring equal number of times as per the original assumption. Although the analysis does not take in to consideration the voltage (gray shade) dependence of capacitance, it can be seen that the profile-b consumes the maximum power under multiplexed condition as predicted in the analysis. Similarly, column 2 of the table confirms that the power consumption is the least for the profile-b (as predicted in the analysis) when bi-level images are displayed when the image is a checkerboard pattern (bi-level image with just ON and OFF pixels). Power dissipation depends on the image statistics as evident from the entries in columns 3 and 4 of the table. It is important to note that the results in the table do not reflect the reduction in power dissipation due to 24% reduction in supply voltage when the select pulse of MSB is reduced by(1/\sqrt{2}). Overall the power dissipation is 73% of the power dissipation of successive approximation technique with ramp (profile-a). The photograph of the prototype is shown in FIG. 9. Typical select waveform, data waveform and the waveform across the pixel are shown in FIG. 10.

### Low Supply Voltage and Low Power

The supply voltage may be high because the amplitude of select pulses for the most significant bits is large. In various embodiments, they can be reduced by increasing the duration of select pulses and reducing their amplitude such that the energy is conserved. It is achieved by pulse-width modulation for the most significant ‘k’-bits and retaining the amplitude modulation for (g-k) bits by modifying the select waveform as shown in FIG. 9. The peak amplitude will be proportional to 2^{(g-k)/2} and its duration (T_{f}) will be (2^{k}−1) time intervals and the number of time intervals increases from ‘g’ to (g−k+2^{k}−1). Power dissipation of discrete versions of triangle and ramp are compared in FIG. 10. Column waveforms will have just one transition of amplitude viz., 2^{(g-k)} (twice the amplitude of peak column voltage). Supply voltage is reduced by the factor:

$${2}^{\frac{- ( k - 1 )}{2}} \sqrt{( g - k + {2}^{k} - 1 ) ( T - {T}_{o\_old} ) / ( g ( T - {T}_{o\_new} ) )}$$

Elimination of the largest transition(s) in the row waveforms and reduction of number of transitions in the data waveform during T_{f} contributes to reduction in power dissipation of row as well as column drivers. Power dissipation of waveforms based on triangle (k=1) and trapezoid (for k=2 to 4) is compared with that of ramp with the ratio (P_{trapezoid}(k)/Pᵣₐₘₚ)·100%. Reduction in power consumption is summarized in Table 2. Reduction in supply voltage is also given within parenthesis in the same table. Reduction in power dissipation may not be much for the discrete version of the triangle (see table 1) but it paves way to trapezoidal waveforms with good reductions power as well as supply voltage. Power dissipation is 47% and supply voltage is 54% as compared to that of discrete ramp waveform when k=4 (i.e., when three most significant bits are subjected to pulse width modulation). This reduction may be achieved with a simple modification to the waveforms and it is important to note that the number of voltages in the addressing waveforms also decreases with increase in ‘k.’

TABLE 2
Comparison of power dissipation of discrete triangle and trapezoid
waveform normalized to that of SAT with discrete ramp.
(P_{trapezoid} (k)/Pᵣₐₘₚ) · 100%

| Number | | | | |
|---|---|---|---|---|
| of bits | k = 1 | K = 2 | k = 3 | k = 4 |
| 4 | 91 | 82 | — | — |
| | | (79) | | |
| 8 | 89 | 72 | 55 | 47 |
| | | (75) | (61) | (54) |
| 12 | 87 | 69 | 49 | 37 |
| | | (74) | (58) | (49) |

Low power consumption and low voltage operation may be achieved when gray shades are displayed with a new select waveform. This method can also be used to reduce the power consumption and supply voltage of multi-line addressing techniques. In various embodiments, hardware complexity of the drivers of successive approximation techniques is the least of all the techniques for gray shades. A good reduction in power consumption and supply voltage of the driver circuit can be achieved without increasing the hardware complexity of the drivers with just a few analog multiplexers. These multiplexers may be common to all stages of the drivers and therefore independent of number of rows and columns in the display.

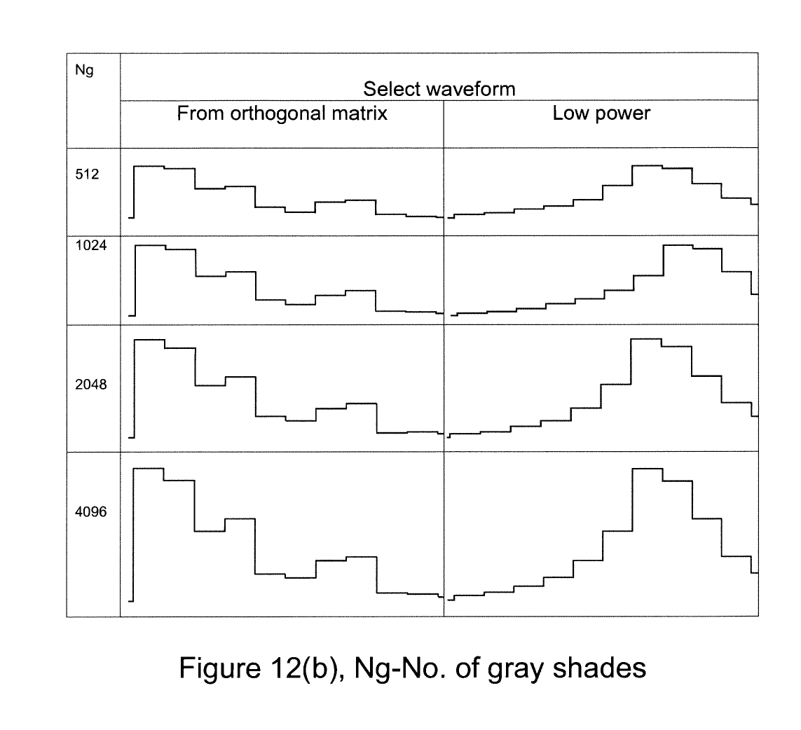

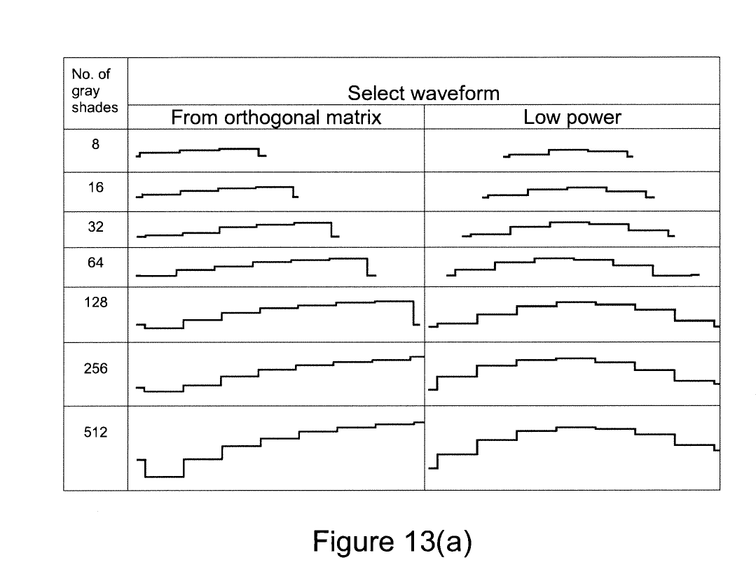

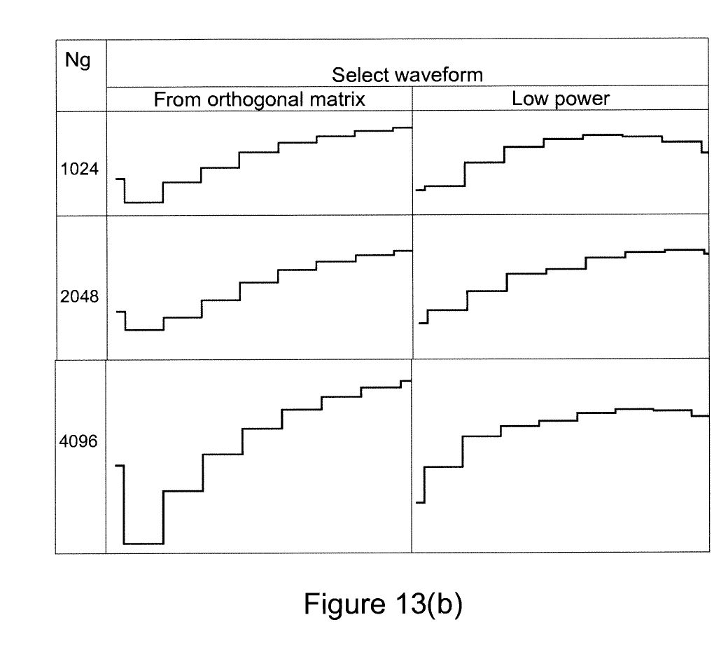

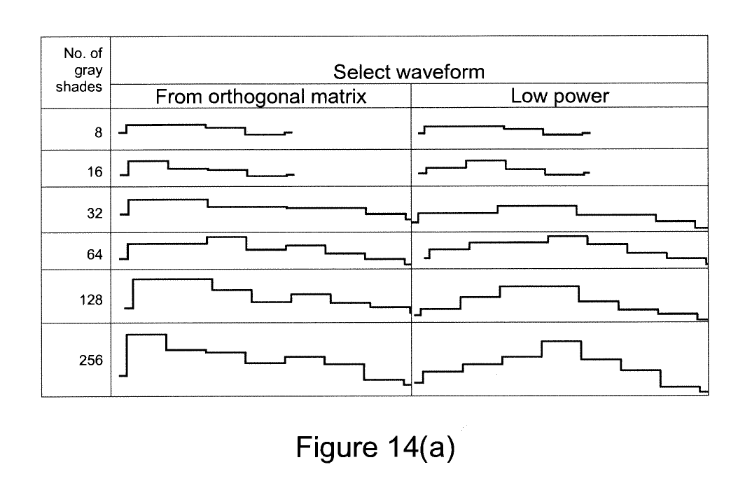

In some embodiments, the select pulses in the select waveforms of other addressing techniques that are based on orthogonal functions or matrices. Wavelets may be rearranged to achieve low power dissipation in the drivers. Further waveforms derived from the orthogonal matrices and the modified waveforms for low power are shown in FIG. 11. Similarly, the waveforms of addressing techniques based on Hadamard matrices, diagonal matrices and wavelets are shown in FIG. 12, FIG. 13 and FIG. 14 respectively. These waveforms are normalized to the threshold voltage so that waveforms of these techniques can be compared side by side. The normalizing factors for the amplitude of select and data waveforms are given in Table 3. Select pulses as well as data pulses are shifted so that the amplitude of transitions of pulses adjacent to each other is reduced without affecting the performance of the display and also to reduce the supply voltage of the drivers as shown in FIGS. 13. Reduction in power dissipation after the rearrangement and the supply voltage as compared to that of successive approximation technique are shown in Table 4 and Table 5 respectively.

TABLE 3
Normalizing factor (V_{c} technique/V_{c} Successive Approximation)

| No. of | Normalizing factor (V_{c} technique/V_{c} | | |
|---|---|---|---|
| gray | Successive Approximation) | | |
| shades | Diagonal matrix | Hadamard matrix | Wavelet |
| 8 | $\frac{1}{3}$ | $\frac{1}{\sqrt{3}}$ | $\sqrt{\frac{2}{3}}$ |
| 16 | $\frac{1}{2}$ | $\frac{1}{\sqrt{4}}$ | $\sqrt{\frac{1}{2}}$ |
| 32 | $\frac{1}{5}$ | $\frac{1}{\sqrt{5}}$ | $\sqrt{\frac{4}{5}}$ |
| 64 | $\frac{1}{3}$ | $\frac{1}{\sqrt{6}}$ | $\sqrt{\frac{2}{3}}$ |
| 128 | $\frac{1}{7}$ | $\frac{1}{\sqrt{7}}$ | $\sqrt{\frac{4}{7}}$ |
| 256 | $\frac{1}{4}$ | $\frac{1}{\sqrt{8}}$ | $\sqrt{\frac{1}{2}}$ |
| 512 | $\frac{1}{9}$ | $\frac{1}{\sqrt{9}}$ | $\sqrt{\frac{2}{3}}$ |
| 1024 | $\frac{1}{5}$ | $\frac{1}{\sqrt{10}}$ | $\sqrt{\frac{3}{5}}$ |
| 2048 | $\frac{1}{11}$ | $\frac{1}{\sqrt{11}}$ | $\sqrt{\frac{8}{11}}$ |
| 4096 | $\frac{1}{6}$ | $\frac{1}{\sqrt{12}}$ | $\sqrt{\frac{2}{3}}$ |

TABLE 4
Comparison of Average Power Dissipation in Drivers for
Several Addressing techniques (After rearrangement)

| | Percentage Power dissipation with | | |
|---|---|---|---|
| | respect to successive approximation | | |
| No. of | (after rearranging the pulses) | | |
| gray | | Hadamard | |
| shades | Diagonal matrix | matrix | Wavelet |
| 8 | 90.61 | 103.02 | 98.77 |
| 16 | 87.02 | 95.41 | 88.16 |
| 32 | 85.75 | 87.25 | 76.69 |
| 64 | 68.31 | 81.98 | 63.57 |
| 128 | 65.74 | 74.15 | 52.75 |
| 256 | 54.93 | 66.18 | 51.27 |
| 512 | 55.81 | 58.66 | 40.97 |
| 1024 | 66.77 | 57.57 | 41.81 |
| 2048 | 59.32 | 53.45 | 39.05 |
| 4096 | 60.28 | 49.26 | 31.64 |

TABLE 5
Comparison of Supply Voltage of Addressing techniques

| | Percentage supply voltage with | | |
|---|---|---|---|
| | respect to successive approximation | | |
| No. of | (after rearranging the pulses)* | | |
| gray | | Hadamard | |
| shades | Diagonal matrix | matrix | Wavelet |
| 8 | 100.16 | 127.42 | 98.55 |
| 16 | 95.92 | 128.04 | 120.71 |
| 32 | 91.59 | 125.69 | 98.70 |
| 64 | 86.53 | 121.96 | 98.55 |
| 128 | 81.46 | 117.64 | 91.25 |
| 256 | 76.55 | 113.16 | 95.71 |
| 512 | 71.90 | 108.77 | 81.67 |
| 1024 | 67.62 | 104.58 | 67.81 |
| 2048 | 63.64 | 100.66 | 76.55 |
| 4096 | 60.07 | 97.02 | 72.25 |

*For N = 100

### Multi-Line Addressing (MLA):

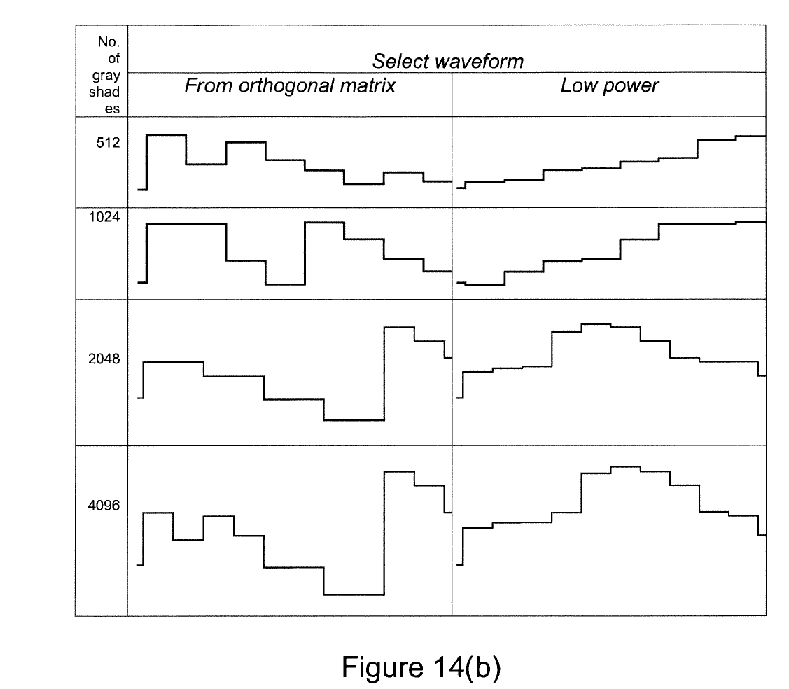

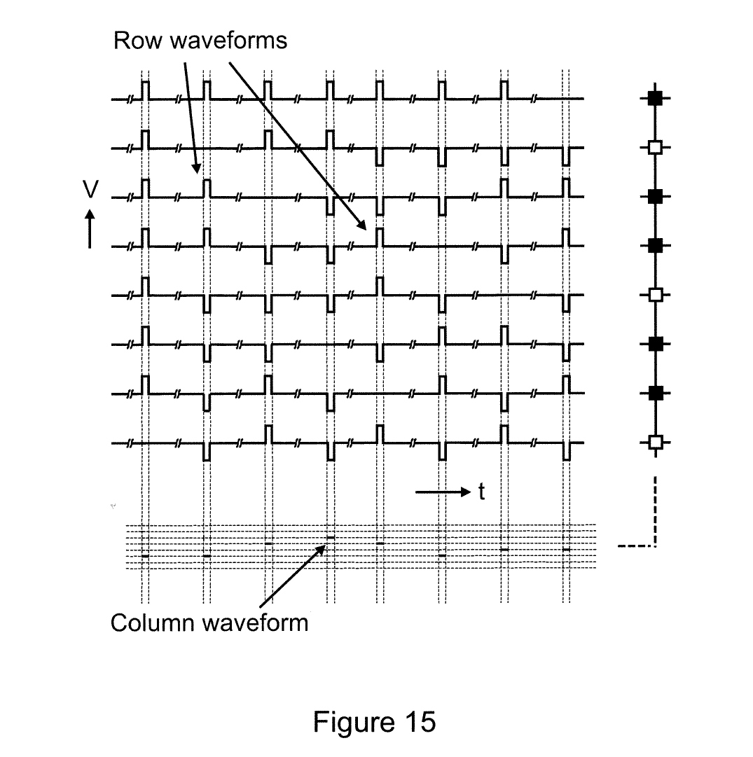

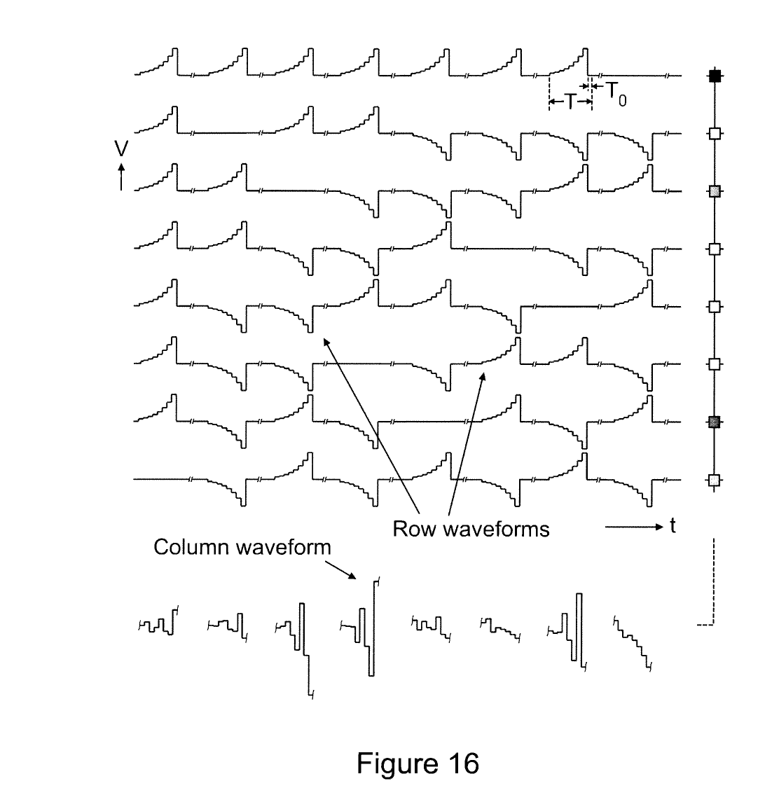

Typical waveforms of distributed select pulses for displaying bi-level images are shown in FIG. 15. Low power consumption may be achieved by adapting multi-step waveform profiles as shown in FIGS. 16 and 17. Voltage across all pixels may be brought to zero during the dead time (T₀) to avoid brightness non-uniformity arising from distortion in the addressing waveforms due to large time constant. The multi-step waveform profile that is obtained by arranging the select pulses of alternate bits so that the resulting waveform has ascending and descending steps (discrete version of triangular waveform) is useful to reduce power dissipation. In various embodiments, these profiles are universal in the sense that it can be combined with any addressing technique. We have adopted the same waveform here for the multi-line addressing. The multi-step waveform profile in FIG. 17 may be more efficient than that in FIG. 16 and may achieve lower power consumption. Duty cycle control is useful to reduce cross talk among pixels when the time constant of driver circuit is large. However, the addition of one more voltages in the column waveform may increase the number of voltages to 9 and the standard drivers may not be used. Hardware utilization may be poor even in case one opts for custom designed drivers. A sparse orthogonal matrix of equation (24) with six non-zero elements in each column may be used but the reduction in supply voltage may be better (for large matrices; N>49) with sparse matrix of equation (25) that has seven non-zero elements in each column.

$$\begin{matrix}[ \begin{matrix}0 & + {V}_{r} & + {V}_{r} & + {V}_{r} & 0 & + {V}_{r} & + {V}_{r} & + {V}_{r} \\ + {V}_{r} & + {V}_{r} & - {V}_{r} & 0 & + {V}_{r} & + {V}_{r} & - {V}_{r} & 0 \\ + {V}_{r} & - {V}_{r} & 0 & + {V}_{r} & + {V}_{r} & - {V}_{r} & 0 & + {V}_{r} \\ + {V}_{r} & 0 & + {V}_{r} & - {V}_{r} & + {V}_{r} & 0 & + {V}_{r} & - {V}_{r} \\ 0 & + {V}_{r} & + {V}_{r} & + {V}_{r} & 0 & - {V}_{r} & - {V}_{r} & - {V}_{r} \\ + {V}_{r} & + {V}_{r} & - {V}_{r} & 0 & - {V}_{r} & - {V}_{r} & + {V}_{r} & 0 \\ + {V}_{r} & - {V}_{r} & 0 & + {V}_{r} & - {V}_{r} & + {V}_{r} & 0 & - {V}_{r} \\ + {V}_{r} & 0 & + {V}_{r} & - {V}_{r} & - {V}_{r} & 0 & - {V}_{r} & + {V}_{r}\end{matrix} ] & ( 24 ) \\ [ \begin{matrix}+ {V}_{r} & + {V}_{r} & + {V}_{r} & + {V}_{r} & + {V}_{r} & + {V}_{r} & + {V}_{r} & 0 \\ + {V}_{r} & 0 & + {V}_{r} & + {V}_{r} & - {V}_{r} & - V & - {V}_{r} & - {V}_{r} \\ + {V}_{r} & + {V}_{r} & 0 & - {V}_{r} & - {V}_{r} & - {V}_{r} & + {V}_{r} & + {V}_{r} \\ + {V}_{r} & + {V}_{r} & - {V}_{r} & - {V}_{r} & + {V}_{r} & 0 & - {V}_{r} & - {V}_{r} \\ + {V}_{r} & - {V}_{r} & - {V}_{r} & + {V}_{r} & + {V}_{r} & - {V}_{r} & 0 & + {V}_{r} \\ + {V}_{r} & - {V}_{r} & - {V}_{r} & 0 & - {V}_{r} & + {V}_{r} & + {V}_{r} & - {V}_{r} \\ + {V}_{r} & - {V}_{r} & + {V}_{r} & - {V}_{r} & 0 & + {V}_{r} & - {V}_{r} & + {V}_{r} \\ 0 & - {V}_{r} & + {V}_{r} & - {V}_{r} & + {V}_{r} & - {V}_{r} & + {V}_{r} & - {V}_{r}\end{matrix} ] & ( 25 )\end{matrix}$$

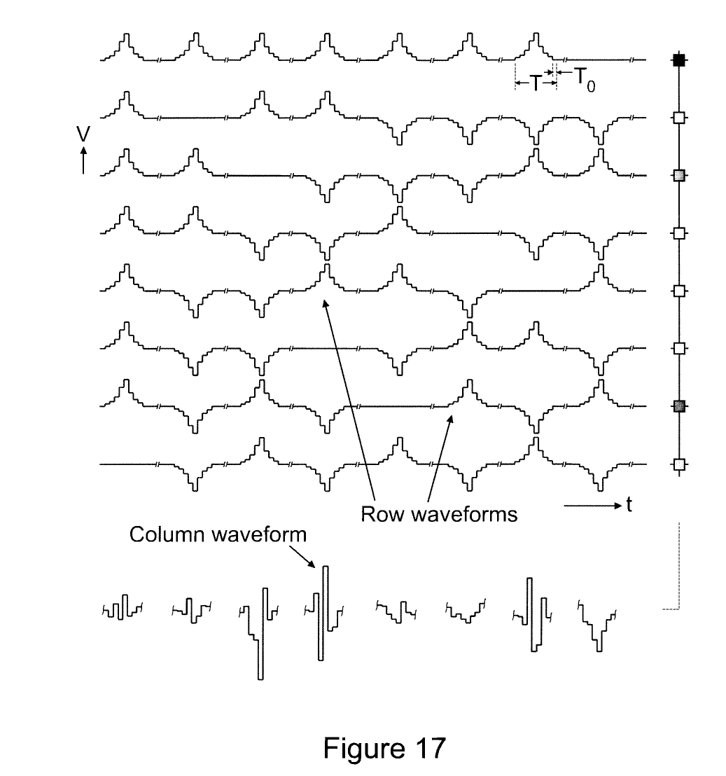

Hardware utilization of row drivers may be poor in the multi-line addressing techniques because there are three voltages in the row waveform. In some embodiments, an additional voltage can be easily incorporated without increasing the hardware complexity. Three level voltage drivers may have a 2-bit shift register and a 2-bit latch in each stage (row in the display). The shift registers and latches may be better utilized to select one-of-four voltages than one-of-three voltages. In various embodiments, we have solved this problem by modifying the addressing waveforms and have achieved full utilization of both row and column drivers by introducing one of the data (column) voltages as an additional voltage in the row waveform and the same voltage is applied to the columns to achieve zero voltage across all pixels (‘dead time’) as shown in FIG. 18.

TABLE 6
Comparison of average power dissipation in the drivers.

| | | Ratio of average |
|---|---|---|
| | | power dissipation |
| | Ratio of average power | of discrete triangular |
| | dissipation of discrete ramp | based waveform |
| Number of | based waveform to that of SAT | to that of SAT with |
| gray shades | with distributed pulses (in %) | distributed pulses (in %) |
| 4 | 76.43 | — |
| 8 | 69.70 | 65.51 |
| 16 | 67.00 | 61.14 |
| 32 | 65.79 | 59.17 |
| 64 | 65.21 | 58.23 |
| 128 | 64.92 | 57.77 |
| 256 | 64.78 | 57.54 |

Any one of the data voltages (say ‘xV_{c}’) may be applied to all the rows and columns of the display and the difference will be zero. No additional voltages may have to be accommodated in the data drivers and the sparse matrices with seven non-zero elements in each column may be used to drive the display. In various embodiments, such an improvement is significant because the number of column drivers is large and is equal to the number of columns in the display. Reduction in power dissipation may be about the same as that of the select waveforms in FIG. 17. Average power dissipation of successive approximation technique with discrete versions of ramp and triangular select waveforms are compared with that of distributed waveform of SAT in Table 6. It is important to note that the reduction in power dissipation may be more for large number of gray shades. Supply voltage of the driver circuit may be equal to that of SAT based MLA wherein 7 rows are selected simultaneously when sparse matrix of order eight is used to scan the display. The technique is demonstrated with a 32×32 matrix LCD. Details of implementation are discussed in the following section.

### Example

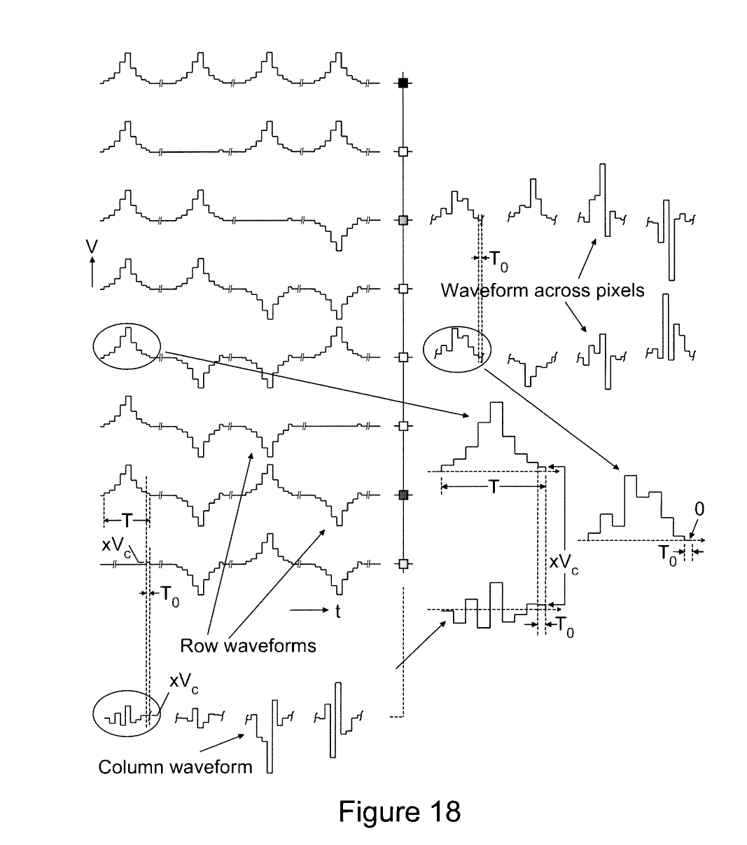

The technique is demonstrated with a 32×32 matrix LCD by displaying 256 gray shades. The controller has been implemented with simple binary counter and Look-up Tables on a Complex Programmable Logic Device (CPLD) (XCR3256XL), by utilizing about 96 macro cells that includes 63 registers and 255 product terms. Typical addressing waveforms are shown in FIG. 19. Some additional details of hardware are as follows:

Hadamard, Walsh, and diagonal matrices of order 8 are stored in the form of a Look-Up Table (LUT) and the second LUT contains the mask elements to introduce zeros to obtain the sparse matrices. The combined out of the two LUTs is used as data for the row drivers and to generate the column signal. Ex-OR gates are used to compare the sign of elements of rows in a column of the orthogonal matrix with corresponding data bits and a counter is used to obtain the column signal.

The image is stored in a bit-mapped memory (BMM). A binary counter is used in generating the control signals and addresses. Lower order 3 bits of the counter are used as row address of LUT and BMM; the next 5 bits are used as column address of BMM. Eight time intervals are necessary to select each subgroup to display 256 gray shades and a 3-bit counter is used for this purpose. An eight-bit counter is used to control the duration of dead time. It is controlled in 256 steps and the maximum duration could be equal to the duration of one select pulse. Two of higher order bits are used to select one of the four subgroups and 3-bits are used to choose the select vectors (columns of sparse matrix). Polarity reversal for DC free operation is done at the end of one frame. Two voltage level generators are used alternately to stabilize the voltages that are fed to the drivers.

TABLE 7
Response times (ms) when pixels are switched from one gray
shade to another.

| Gray | | | | | | | | | |
|---|---|---|---|---|---|---|---|---|---|
| data | 0 | 31 | 63 | 95 | 127 | 159 | 191 | 223 | 255 |
| 0 | X | 68 | 70 | 66 | 65 | 63 | 60 | 60 | 60 |
| 31 | 74 | X | 70 | 65 | 64 | 62 | 63 | 63 | 61 |
| 63 | 74 | 69 | X | 65 | 63 | 64 | 64 | 62 | 61 |
| 95 | 70 | 65 | 66 | X | 60 | 64 | 63 | 63 | 60 |
| 127 | 67 | 68 | 64 | 60 | X | 50 | 57 | 62 | 56 |
| 159 | 68 | 66 | 64 | 64 | 55 | X | 49 | 58 | 55 |
| 191 | 65 | 65 | 62 | 61 | 63 | 53 | X | 48 | 50 |
| 223 | 62 | 64 | 60 | 61 | 60 | 62 | 50 | X | 48 |
| 255 | 64 | 59 | 59 | 58 | 59 | 58 | 58 | 45 | X |

### Results

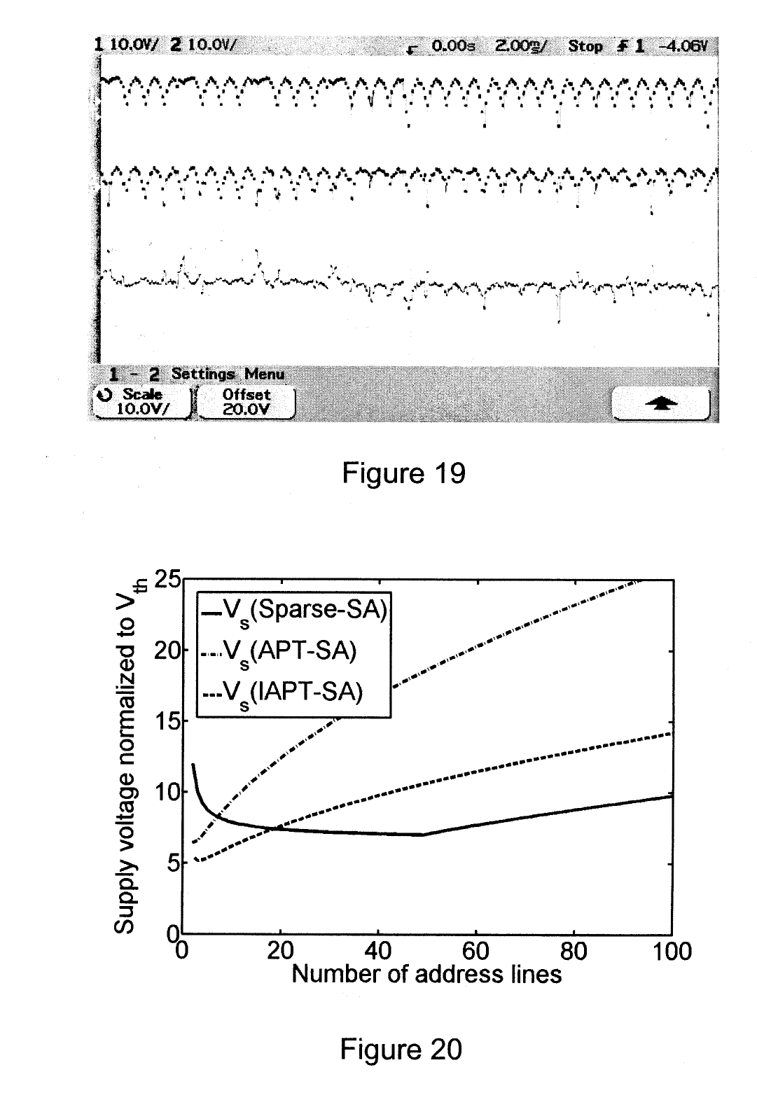

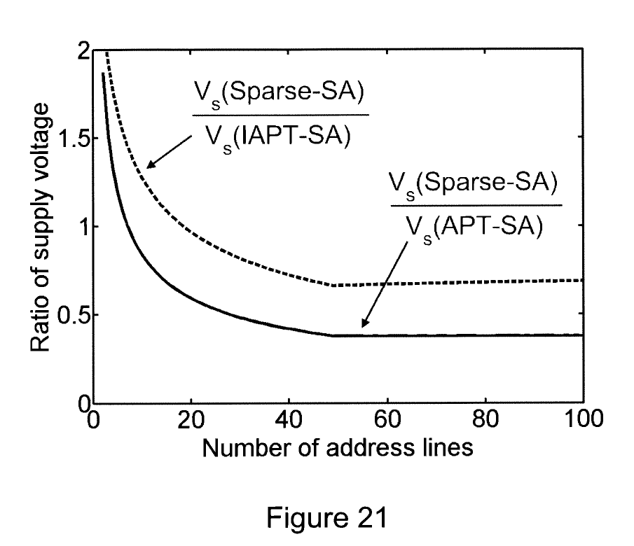

Power dissipation in the analog part of drivers is reduced by 42% when 256 gray shades are displayed by using discrete version of triangular waveform. Switching times (i.e., the time taken to switch from one gray scale to another) were measured using a twisted nematic cell filled with liquid crystal mixture: RO TN 623 and the response times are shown in Table 7. The cell thickness is 5.6 μm and the threshold voltage is 1.66 Volt. The cell is not optimized for short response times but it is important to note that the spread in response times is not high (standard deviation of 5.8 about the mean of 61 ms). Note that the values above the diagonal are the rise times and values below the diagonal are fall times. Supply voltage of this technique is compared with that of SAT based on line-by-line addressing in FIGS. 20 and 21. It is lower by 62% (when the number of lines multiplexed is greater than 49) as compared to successive approximation technique that is based on line-by-line addressing (APT-SA). About 32% reduction in supply voltage is achieved as compared to the successive approximation based on line-by-line addressing and improved Alt and Pleshko technique (IAPT-SA).

In various embodiments, reduction in power dissipation (42% reduction for 256 gray shades), low supply voltage (32% reduction in supply voltage), low hardware complexity of drivers, efficient utilization of hardware in row as well as column drivers, simple controller make it very attractive for portable devices (e.g., mobile phones, personal digital assistant (PDA), digital cameras) where low power consumption is essential.

Those skilled in the art will appreciate that the above functions may be performed by one or more modules to drive an LCD display. It will be appreciated that a “module” may comprise software, hardware, firmware, and/or circuitry. In one example one or more software programs comprising instructions capable of being executable by a processor may perform one or more of the functions of the modules described herein. In another example, circuitry may perform the same or similar functions. Alternative embodiments may comprise more, less, or functionally equivalent modules and still be within the scope of present embodiments. For example, the functions of the various modules may be combined or divided differently.

Further, the above-described functions, modules, and components can comprise instructions that are stored on a storage medium such as a computer readable medium (e.g., RAM, ROM, hard drive, CD, DVD, or flash memory). Some examples of instructions include software, program code, and firmware. The instructions can be retrieved and executed by a processor in many ways.

We claim:

1. A method to form discrete trapezoidal shaped select and/or data waveforms, comprising:
applying a select and/or data pulse corresponding to alternate least significant bits (LSB) to form ascending and descending parts of at least one discrete trapezoid;
reducing amplitudes and increasing widths of most significant bit(s) (MSB) pulse(s) to form a flat part of the at least one trapezoid; and
reducing a number of transitions in the flat region of the at least one trapezoid in addressing waveforms by using pulse width modulation.

2. The method as claimed in claim 1, wherein the select and/or data pulses of odd numbered bit(s) of the LSB form the ascending part and pulses of even numbered bit(s) of the LSB form the descending part.

3. The method as claimed in claim 1, wherein the select and/or data pulses of odd numbered bit(s) of the LSB form the descending part and pulses of even numbered bit(s) of the LSB form the ascending part.

4. The method as claimed in claim 1, further comprising r educing amplitude and increasing width of the select and/or data pulses of the most significant bit(s) with a decrease in a unit pulse width such that a duration of the select and/or data waveform and the refresh rate remain unaltered.

5. The method as claimed in claim 4, wherein the unit pulse width is reduced or increased to change a refresh rate of the LCD.

6. The method as claimed in claim 1, wherein the pulse width modulation is used for about 50% of the most significant bits of gray shade.

7. The method as claimed in claim 1, wherein the number of transitions in the flat region is reduced to just one transition.

8. The method as claimed in claim 1, further comprising driving an LCD using the discrete triangle shaped select and/or data waveforms with a line-by-line addressing technique.

9. The method as claimed in claim 1, further comprising driving an LCD using the discrete triangle shaped select and/or data waveforms with a multi-line addressing technique.

10. A method to form a discrete triangle shaped select and/or data waveform, comprising applying select and/or data pulse corresponding to least significant bits (LSB) to most significant bits (MSB) alternatively to create an ascending part and a descending part to form the discrete triangular waveform by using all gray shade bits for the ascending and the descending parts.

11. The method as claimed in claim 10, wherein the select and/or data pulses of odd numbered bit(s) from LSB to MSB forms the ascending part and that of even numbered bit(s) from MSB to LSB forms the descending part.

12. The method as claimed in claim 10, wherein the select and/or data pulses of odd numbered bit(s) from LSB to MSB forms the descending part and that of even numbered bit(s) from MSB to LSB forms the ascending part.

13. The method as claimed in claim 10, further comprises reducing amplitude and increasing width of the select and/or data pulses of the most significant bits to transform the discrete triangle waveform to a discrete trapezoidal waveform.

14. The method as claimed in claim 10, further comprising driving an LCD using the discrete triangular waveform with a line-by-line addressing technique.

15. The method as claimed in claim 10, further comprising driving an LCD using the discrete triangular waveform with a multi-line addressing technique.

16. A system, comprising:
a Liquid Crystal Display (LCD);
a module configured to drive the LCD, the module configured to apply a select and/or data pulse corresponding to alternate least significant bits (LSB) to form ascending and descending parts of at least one discrete trapezoid, to reduce amplitudes and increasing widths of most significant bit(s) (MSB) pulse(s) to form a flat part of the at least one trapezoid, to reduce a number of transitions in the flat region of the at least one trapezoid in the addressing waveforms by using pulse width modulation, and to drive the LCD utilizing, at least in part, the at least one trapezoid in the addressing waveforms.

17. A system, comprising:
a Liquid Crystal Display (LCD);
a module configured to drive the LCD, the module configured to apply select and/or data pulse corresponding to least significant bits (LSB) to most significant bits (MSB) alternatively to create an ascending part and a descending part to form a discrete triangular waveform by using all gray shade bits for the ascending and the descending parts and to drive the LCD utilizing, at least in part, the discrete triangular waveform in the addressing waveforms.
